(19) United States
(12) Patent Application Publication
(10) Pub. No.: US 2005/0156902 A1
(43) Pub. Date: Jul. 21, 2005

(54) Electronic tablet

(76) Inventors: Roger McPherson, Westminster, CO (US); Karen B. Gray, Longmont, CO (US); James M. Wood, Broomfield, CO (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 10/761,572

(22) Filed: Jan. 20, 2004

(51) Int. Cl. G09G 5/00

(52) U.S. Cl. 345/173; 345/8

(57) ABSTRACT

An electronic viewing tablet is provided with a uni-body display and touch screen system. The device includes a large display, connectors for USB, flash ROM ports (such as Smart Media, Compact Flash and Secure Digital/Multi-Media Flash) protected behind a waterproof access door, a wireless network interface, a momentary contact switch and a waterproof access panel for servicing the internal battery. An inductive charging system may be provided to recharge an internal battery. A microprocessor based electronic communication and control system controls the electronic components of the device. The electronic tablet allows a user to acquire content and applications on a personal computer or network or purchase data and images on removable flash media. Applications, data and images (electronic books, magazines, newspapers, text files, sheet music and “printed” files) may be downloaded to the tablet through a USB connector, a wireless connection, or through a ROM port. Once loaded onto the tablet, written material may be read wherever the user chooses, independent of the computer or network. A user interface presents simple commands to the user, presented in a graphical fashion on a display, allowing the user to navigate the information stored in the device and execute the applications that are present. Soft buttons on the touch screen allow the user to interact with the tablet.

### TECHNICAL FIELD

The present invention relates generally to portable electronic displays, as are commonly used to view data and images, and in particular to electronic capture and display devices which display written material and capture the movements of a stylus, pen or finger over the surface of a touch screen/display component.

### BACKGROUND ART

Current electronic book viewers are generally small format devices, about the size of a paperback book. For the most part, the devices either support viewing written material (“books”) only in a proprietary format or are actual handheld computers with a complicated user interface. A few larger format devices exists but are expensive and have limited battery life (typically about three hours). Moreover, current devices are not particularly rugged and thus prone to damage from being dropped or subjected to moisture or liquids.

Thus, there is a need for a simple to use, affordable, rugged, large format viewing device which displays information stored in standard electronic media formats and which may allow users to annotate the material they are viewing. There is also a need for a device which will allow users to “print” material to the display system from a computer or a network and then remove the device and access the material independent of any computer or network. There is also a need for a device which is capable of accessing material stored on flash ROM cards.

### SUMMARY OF THE INVENTION

The present invention allows a user to acquire data and images on a personal computer or purchase data and images on removable media, such as flash ROM, download the material to a portable display system and “consume” the material wherever (s)he chooses.

The present invention provides a portable, stand alone, display and capture system. The user interfaces with the device via “soft” buttons shown on the display and captured by the touch screen. Marks captured by the touch screen may also be stored as annotations associated with the content being displayed during capture.

The user interface is simple and straightforward. Commands are presented in the form of icons and text on the display and the user executes these commands by touching the area of the display where the icon is shown. There is little need to enter textual data.

Data and applications may be loaded onto the device via a Universal Serial Bus (USB) port, an infrared (IR) port or other wireless interface or through a FLASH ROM port (such as Smart Media, Compact FLASH or Secure Digital/Multi-Media).

A collection of applications are provided which run on a personal computer to facilitate configuring the device and downloading content and applications to the device via the USB or IR port. A wireless or other data communication medium may also be employed.

The internal battery may be charged by inductive charging or may be powered by being plugged directly into a wall outlet.

The USB connector and the FLASH ROM sockets are secured behind a “door”, which forms a water tight seal when closed.

The device is housed in a shock absorbent enclosure, assembled so as to be water proof.

The present invention is a portable, stand alone, display and capture system designed to be low power, light weight, inexpensive, simple to use, water proof, rugged and large format.

### BRIEF DESCRIPTION OF THE DRAWINGS

FIG. 1 is a front perspective view of an electronic tablet of the present invention;

FIG. 2 is a front elevational view thereof;

FIGS. 3A and 3B are left side and right side elevational views thereof;

FIGS. 4A and 4B are top side and bottom side elevational views thereof;

FIG. 5 is a back elevational view thereof with a stand in a retracted position;

FIG. 6 is a back perspective view thereof with the stand in an extended position;

FIG. 7 is a close up perspective of a sliding connector access door in the open position;

FIG. 8 is a block diagram of the electronic tablet;

FIG. 9 is an exemplary screen shot illustrating the user interface of the electronic tablet, and

FIG. 10 is a close up perspective of a hinged connector access door in the open position.

### DETAILED DESCRIPTION

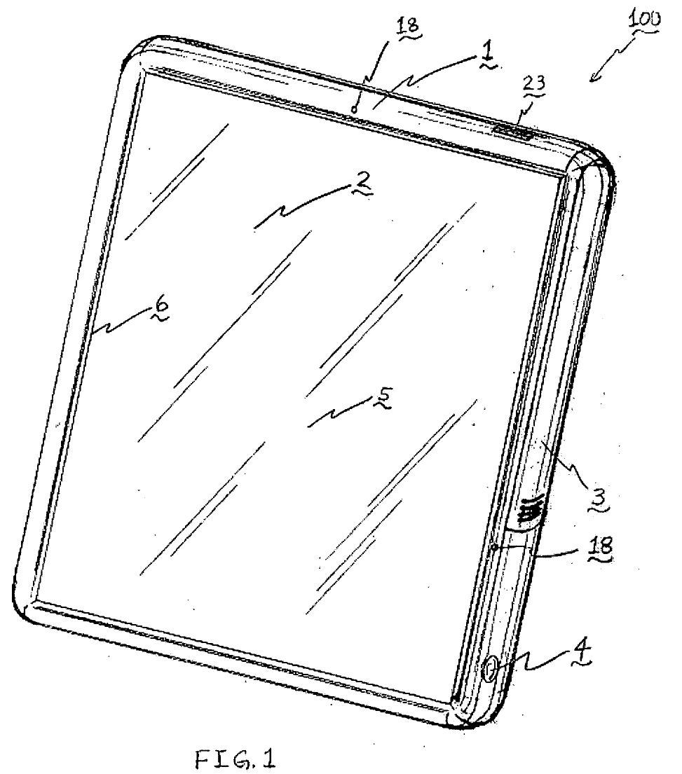

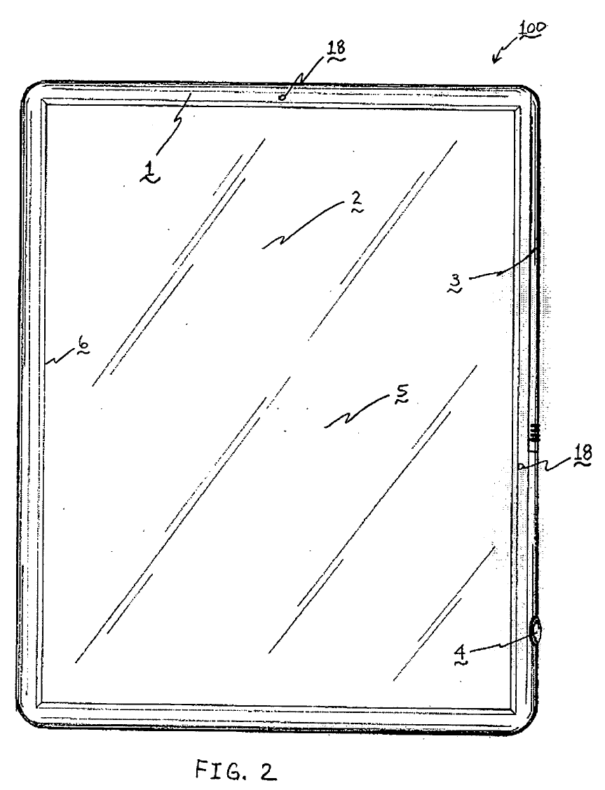

FIG. 1 is a front perspective view and FIG. 2 is an elevational view of an embodiment of an electronic tablet 100 of the present the invention. A display 2 is relatively large, such as 8.5″×11″, and may be a color LCD, active or passive matrix, Organic LED, E-Ink or any other suitable low power display. For clarity and ease of reading, the minimum resolution is preferably 1024×768 pixels. For user comfort and extended battery life, one or more photodetectors 18, located near the center of two adjacent sides of the enclosure 1 (or any other satisfactory location), detect ambient light conditions and adjust backlighting of the display 2 for optimum viewing. Overlaying the display 2 is a touch screen 5. The touch screen 5 may be one of several technologies which allow either finger or stylus use. The touch screen 5 and the display 2 are sealed 6 into an enclosure 1 in a water tight fashion. A waterproof, momentary contact switch 4 is recessed into an edge of the enclosure 1 and turns the unit on and off and may also serve to reset the unit. A door 3 provides a waterproof cover for connectors for USB and flash ROM ports. The exterior of the enclosure 1 is preferably fabricated from a shock absorbent, slip resistant plastic or other like material. The outer edges of the enclosure 1 may be rounded to provide the user with a comfortable experience while holding the tablet 100. When the door 3 is closed, the tablet is sealed from the outside environment and thus waterproof, preferably to a depth of about one foot.

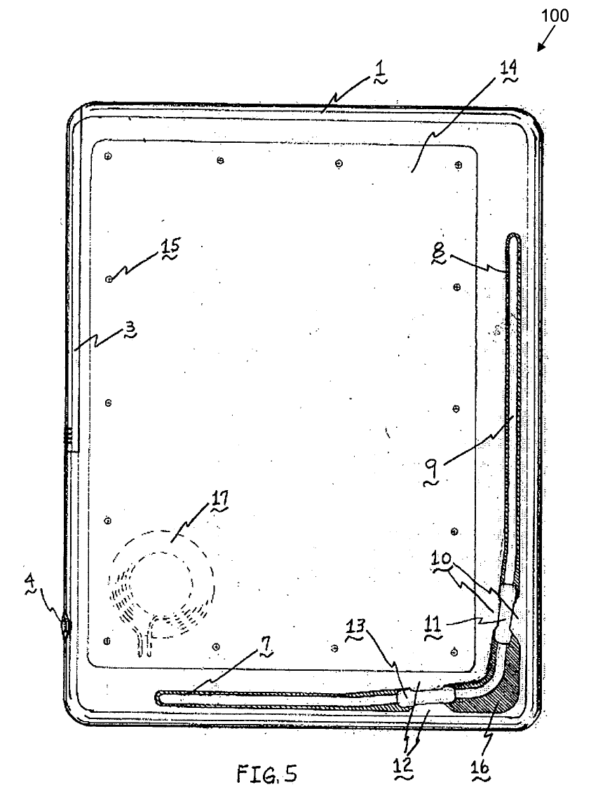

Consequently, the tablet 100 is ruggedized to prevent damage due to physical shock or liquids (such as water, coffee and other common household fluids). The top, sides and back of the enclosure 1 are preferably constructed of pliable, shock absorbing material. A thin plastic sheeting over the display/touch screen surface may be used as protection from shock and scratches. The momentary contact switch 4 is preferably constructed with thick pliable plastic, designed to withstand tens of thousands of pushes. A battery access panel (see FIG. 5) is ridged with a plastic O-ring seal. The connector access door 3 may be of hard plastic and slides (or hinges) to the closed position to form a seal between the outside of the door and the inside of the enclosure 1.

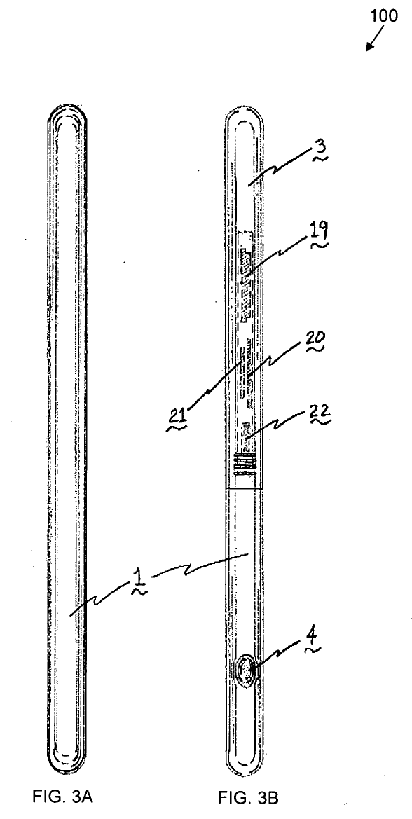

FIGS. 3A and 3B are left and right side elevational views of the electronic tablet 100. The connector access door 3 is shown in the FIG. 3B in the closed position, covering the USB connector 22 and connectors for removable flash memory, such as for Compact Flash 19, Smart Media 20 and Multi-Media/Secure Digital Flash 21.

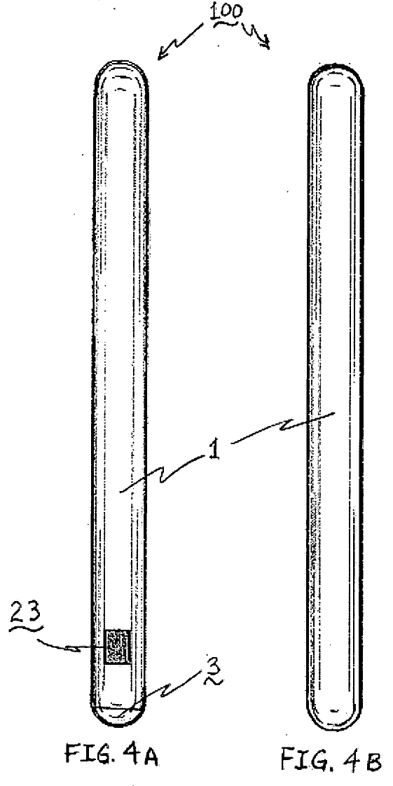

FIGS. 4A and 4B are top and bottom side elevational views of the electronic tablet 100. If desired, infrared an port 23 may be located anywhere in the case 1 and is shown in FIG. 4A in the right edge of the case 1.

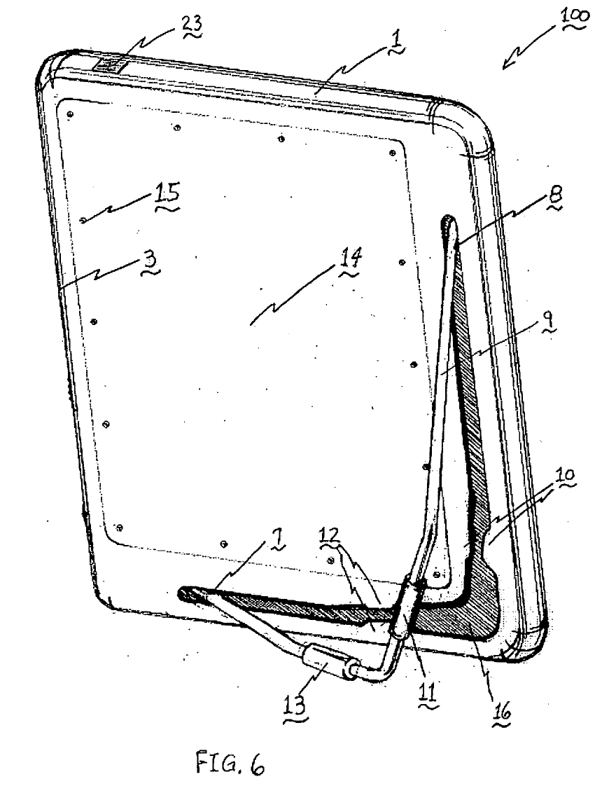

FIG. 5 is a back elevational view of the electronic tablet 100. Access to a rechargeable battery (not shown) is made through the access panel 14 which is secured to the enclosure 1 with fasteners 15. As previously noted, the access panel 14 is preferably fastened to the enclosure 1 in a waterproof manner. An integrated stand 9 may be included and is shown in a retracted state. When the stand 9 is retracted, tabs 10 and 12 securely hold the stand in the retracted state. It will be appreciated that other means may be used to secure the stand 9. When extended (as illustrated in FIG. 6), the stand 9 swivels out on hinge points 7 and 8. Pads 11 and 13, constructed of non-skid material, prevent the tablet 100 from slipping when set on a surface. The stand 9 may be held in the extended position by tabs (not shown) in contact with the ends of the stand 9. The maximum extension is controlled by the ends of the stand 9 contacting a stop (not shown), thus preventing further extension. A hollowed out area 16 into which the stand 9 retracts has no sharp edges. The widest area of the recessed area 16 is provided so that the user can place a finger inside the recess and swivel out the stand 9.

A high frequency pick up coil 17 for the inductive charging system is shown inside the tablet 100. It is preferably situated near a corner of the device so that an auxiliary charging coil can be easily clamped over the side of the device and lay over the pick up coil 17.

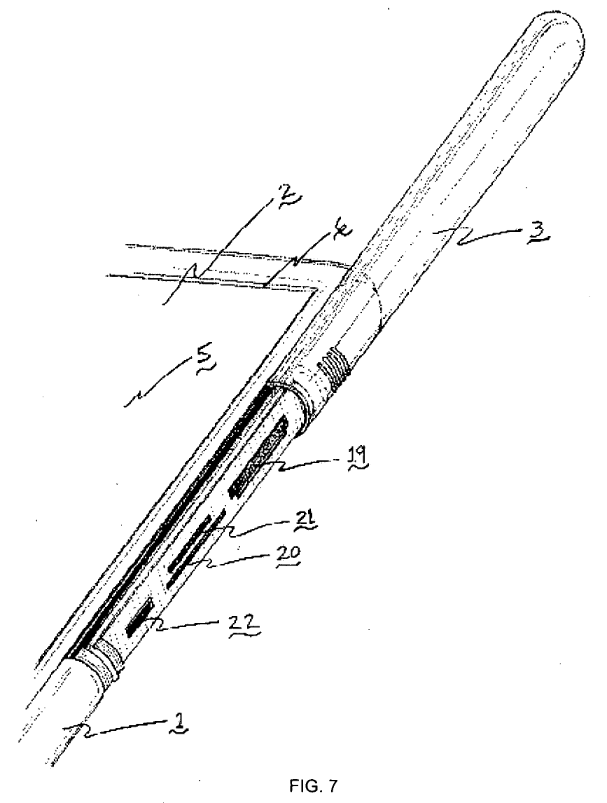

FIG. 7 illustrates the connector access door 3 in the open position. The door, shown sliding up, may slide down to give access to the connector. The door 3 can slide to a first detent, allowing access to the USB connector 22 only, or to a second detent, allowing access to both the USB connector 22 and the flash ROM connectors 20 and 21, or to a third detent, allowing access to the USB connector 22 and all of the flash ROM connectors 19, 20 and 21.

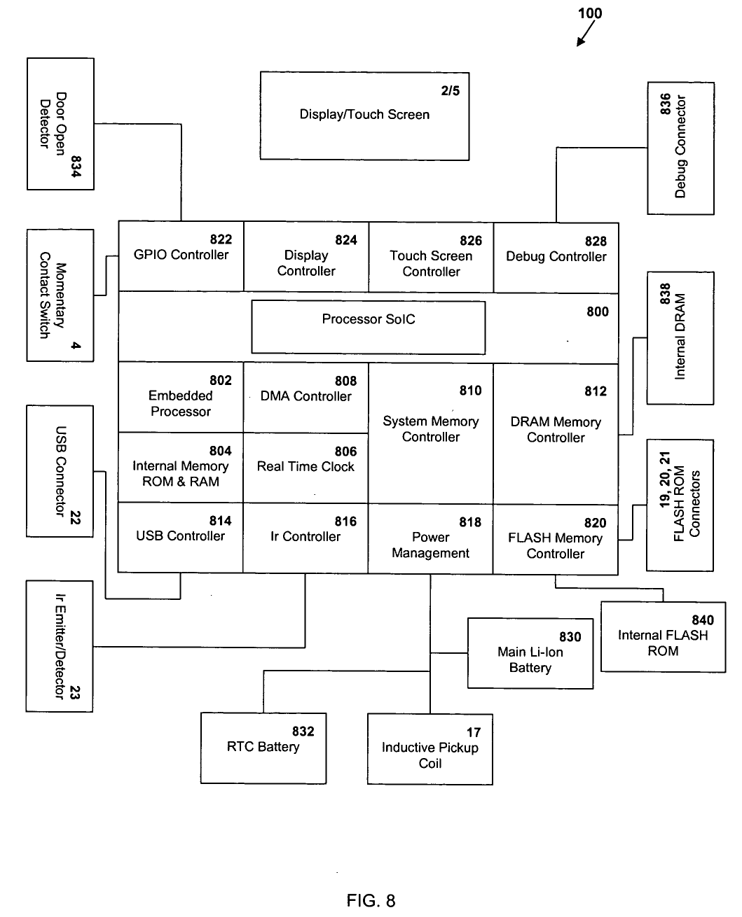

FIG. 8 is a block diagram of an electronic tablet 100 of the present invention. A highly integrated IC 800, such as might be packaged as an ultra very large scale integrated circuit (U-VLSIC), manages all facets of the operation of the tablet 100. Examples of such an system IC include the Samsung S3C2410x and the Intel PXA26x. The system IC preferably includes: an embedded processor 802; internal memory 804; a system clock 806; a DMA controller 808; a system memory controller 810; a DRAM memory controller 812; a USB controller 814; an IR or other wireless communications controller 816; a power management controller 818; a flash memory controller 820; a general I/O controller 822; a display controller 824; a backlight controller 842; a touch screen controller 826; and a debug controller 828. It will be appreciated that other system ICs may be used and that any of the controllers integrated within the illustrated system IC 800 may instead be external.

A display 2 and touch screen 5 are coupled to the system IC 800 through the display controller 824 and touch screen controller 826, respectively. The backlight (not shown) for the display 2 and the ambient light detector(s) 18 are coupled to the system IC 800 through the backlight controller 842. The rechargeable battery 830, inductive pickup coil 17 and a battery 832 for the internal clock 806 are coupled to the system IC 800 through the power management controller 818. If a DC adapter is used instead to operate and/or charge the tablet 100 through a conventional AC wall outlet, it may be coupled through the power management controller 818; such an adapter may plug into the tablet 100 through an appropriate connector situated behind the water tight sliding door 3. The IR emitter/detector 23 is coupled to the system IC 800 through the IR controller 816. Other wireless communications devices, if used, would be coupled to the system IC 800 through appropriate controllers. The USB connector 22 is coupled to the system IC 800 through the USB controller 814. The on/off/reset switch 4 and other like switches and sensors, such as a door-open detector 834, are coupled to the system IC 800 through the GPIO controller 822. Diagnostics and debugging may be performed via a debug connector 836 coupled to the system IC 800 through the debug controller 828, Internal DRAM 838 is coupled to the system IC 800 through the DRAM controller 812. Internal flash ROM 840 as well as the connectors 19, 20 and 21 for external flash media are coupled to the system IC 800 through the flash memory controller 820.

The electronic tablet 100 allows a user to acquire data and images (collectively referred to as “content”) and applications on a personal computer or network or purchase data and images on removable flash media. Applications may be provided to run on a personal computing system to facilitate configuring the tablet 100 and downloading content and applications to the tablet 100. When the tablet 100 is connected to the computer, software provided with the tablet 100 and executed on the embedded processor 802 configures the computer to see the device as both a networked storage device and as a networked printer. When the tablet 100 is used as a storage device, the user of the computer can cause data to be stored in the internal memory 838 or 840 of the tablet 100. When used as a printer, a print driver installed on the computer causes the information being printed to be formatted for display on the tablet 100 and then copies the formatted data file to the tablet 100. Applications, data and images (electronic books, magazines, newspapers, text files, sheet music and “printed” files; that is, anything that can be printed to a printer) may be downloaded to the tablet 100 via the USB connector 22, or via one of the flash ROM connectors 19, 20 and 21. Appropriate hardware and software may also be employed to enable downloading applications and content via wireless infrared or radio frequency (RF) transmission or other data communication medium. The user may then “consume” the information distant from computers and computer networks. Once loaded into the internal memory 838 or 840 of the tablet 100, written material (such as e-books) may be read, and still and video images may be viewed, wherever the user chooses, independent of the computer or network.

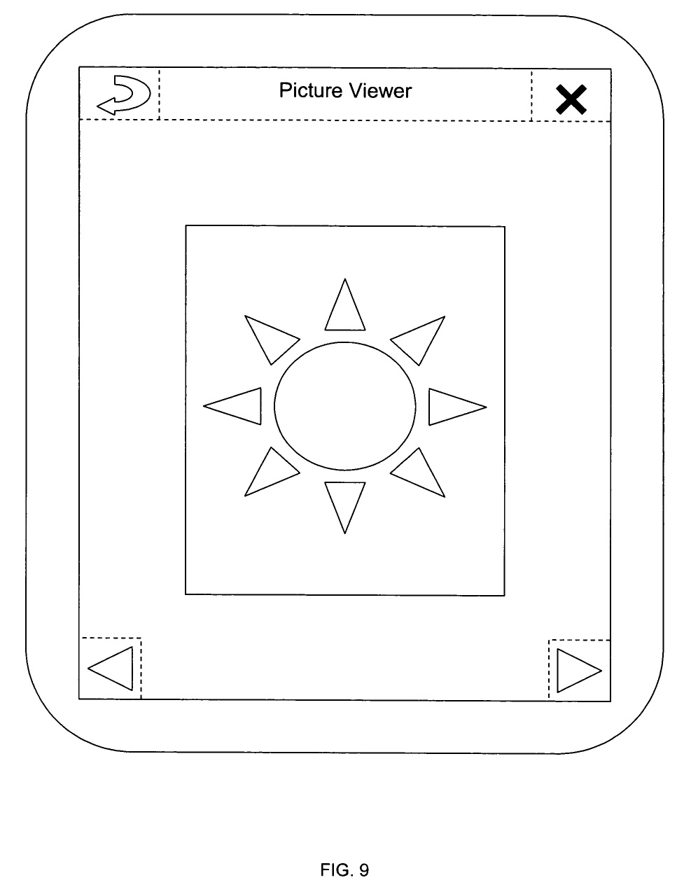

As illustrated in FIG. 9, a user interface presents simple commands to the user, presented in a graphical fashion (such as with icons) on the display 2, allowing the user to navigate the information stored in the device and execute the applications that are present. The user interacts with the tablet 100 via “soft” buttons on the touch screen 5, using a finger or stylus to touch the area of the display 2 where an icon representing the desired command is shown. When viewing data stored on the tablet 100, the user may annotate the content by making marks with the stylus. These marks are captured and stored with the content being displayed. Captured markings may be retrieved from the device by moving the appropriate file(s) to one of the removable flash ROM devices. When connected to a computing system, the annotated data may also be uploaded to the computing system via the USB connection or other transmission means.

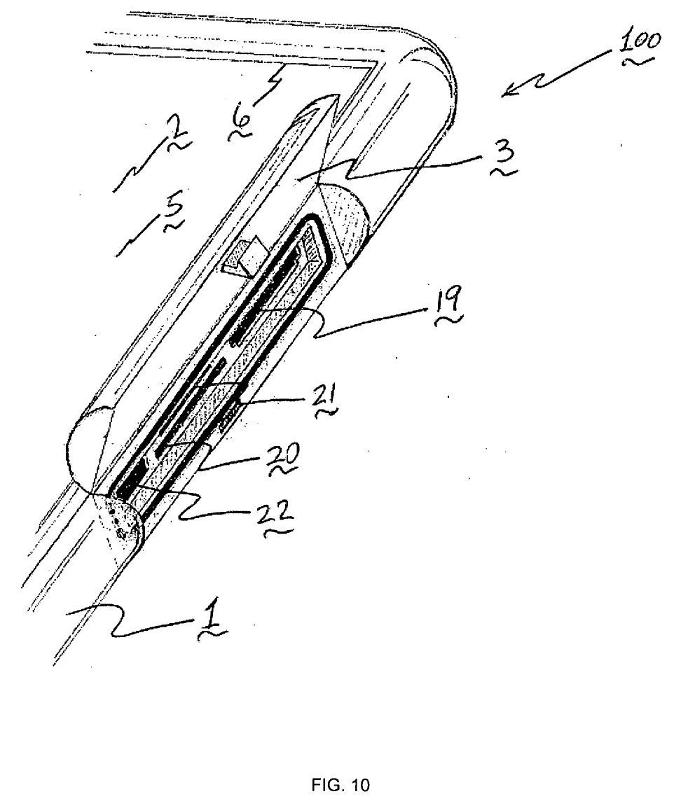

FIG. 10 presents another method of realizing the access door 3. In this figure, the door is seen hinged to the top of the case and in the open position. The access door 3 achieves a watertight seal by compressing the O-Ring seal xx onto the inner face xx of the door 3.

The device is preferably powered by the internal rechargeable battery 830. Although charging may be effected by plugging the unit into a wall outlet, charging may also be effected with the inductive charger 17, transmitting power through the case 1. A microprocessor based control system regulates the battery charging process. A small, clamp-on charging device may be provided to radiate the energy into the case 1 at a frequency of approximately 100 KHz although other inductive charging means may also be used.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

1. An electronic tablet, comprising:
a housing;
a data port within the housing for receiving viewable content in a digital format;
a processor within the housing and coupled to the data port, the processor programmed to execute instructions for converting the digital formatted content into a displayable format;
a display coupled to the processor for displaying the content and secured to the housing in a waterproof manner; and
an access door in the housing associated with the data port and having a closed position wherein the data port is sealed in a waterproof manner behind the access door.

2. The electronic tablet of claim 1, further comprising:
a rechargeable battery within the housing; and
a inductive charger within the housing for recharging the battery.

3. The electronic tablet of claim 2, wherein the inductive charger comprises a high frequency coil.

4. The electronic tablet of claim 3, wherein the high frequency coil operates at a frequency of about 100 kHz.

5. The electronic tablet of claim 1, wherein the data port comprises a USB port connectable to a computer.

6. The electronic tablet of claim 1, wherein the data port comprises a flash ROM port for receiving a flash ROM card.

7. The electronic tablet of claim 1, further comprising a touch input screen overlaid on the display and coupled to the processor for receiving user input.

8. The electronic tablet of claim 1, wherein the housing comprises a shock absorbing material.

9. The electronic tablet of claim 1, further comprising a wireless interface for receiving the viewable content in a digital format.

10. The electronic tablet of claim 9, wherein the wireless interface comprises an infrared interface.

11. The electronic tablet of claim 9, wherein the wireless interface comprises a an RF interface.

12. The electronic tablet of claim 1, wherein the processor is further programmed with instructions for configuring the electronic tablet as a printer whereby content is receivable from a coupled computer in a print operation to the electronic tablet and displayed on the display.

13. The electronic tablet of claim 1, wherein the processor is further programmed with instructions for configuring the electronic tablet as a storage device whereby content is receivable from a coupled computer and stored in a memory.

14. The electronic tablet of claim 1, wherein the housing has dimensions of approximately 8.5 inches by 11 inches.

15. An apparatus for displaying electronic content, comprising:
a housing;
a USB port within the housing for receiving viewable content in a digital format from a connectable computer;
a processor within the housing and coupled to the data port, the processor programmed to execute instructions for converting the digital formatted content into a displayable format;
a display coupled to the processor for displaying the content and secured to the housing in a waterproof manner;
a touch input screen overlaid on the display and coupled to the processor for receiving user input;
an access door in the housing associated with the data port and having a closed position wherein the data port is sealed in a waterproof manner behind the access door; and
a rechargeable battery within the housing.

16. The apparatus of claim 15, further comprising a flash ROM port for receiving a flash ROM card storing content in a digital format, the flash ROM port located proximate to the USB port such that, when the access door is in the closed position, the flash ROM port is sealed in a waterproof manner behind the access door.

17. The apparatus of claim 15, further comprising a plurality of flash ROM ports, each for receiving a flash ROM card storing content in a digital format, the plurality of flash ROM ports located proximate to the USB port such that, when the access door is in the closed position, the flash ROM ports are sealed in a waterproof manner behind the access door.

18. The apparatus of claim 15, further comprising a inductive charger within the housing for recharging the battery.

19. The apparatus of claim 15, wherein the housing has dimensions of approximately 8.5 inches by 11 inches.

20. The apparatus of claim 15, wherein the processor is further programmed with instructions for:
receiving user-generated input from the touch input screen and representative of written annotations of displayed content; and
storing the annotations with the displayed content whereby the annotations are displayed with the content.
